(19) United States
(12) Patent Application Publication
(10) Pub. No.: US 2025/0236278 A1
(43) Pub. Date: Jul. 24, 2025

(54) METHOD FOR FILLING A BRAKE SYSTEM OF A VEHICLE AND CONTROL DEVICE FOR A BRAKE SYSTEM OF A VEHICLE

(71) Applicant: Robert Bosch GmbH, Stuttgart (DE)

(72) Inventors: Alexander Horvath, Korntal-Muenchingen (DE); Martin Langsch, South Lyon, MI (US)

(21) Appl. No.: 18/858,775

(22) PCT Filed: Jul. 13, 2023
(86) PCT No.: PCT/EP2023/069420

§ 371 Date: Oct. 22, 2024

(30) Foreign Application Priority Data
Jul. 29, 2022 (DE) 10 2022 207 837.3

(51) Int. Cl. B60T 17/22; B60T 15/04

(52) U.S. Cl. CPC B60T 17/222; B60T 15/04

(57) ABSTRACT

A method for filling a brake system of a vehicle. A filling installation is connected to the brake system and a control device of the brake system is activated. The control device monitors a pressure signal of a pressure sensor of the brake system in order to detect a filling operation carried out by the filling installation, wherein in response to detecting a start of the filling operation, valves of the brake system are activated by the control device and in response to detecting an end of the filling operation, the valves are deactivated by the control device.

### FIELD

The present invention relates to a method for filling a brake system of a vehicle, a control device for a brake system of a vehicle, and a corresponding computer program product.

### BACKGROUND INFORMATION

A brake system of a vehicle can be filled for the first time during vehicle production. For this purpose, for example, a filling head of a filling installation can be placed on a reservoir of the master brake cylinder. In order to avoid air pockets, air can be drawn off from the brake system via the filling head and brake fluid can be filled into the deflated brake system. The brake fluid can be filled into the brake system at excess pressure.

If the brake system comprises an ABS or ESP, for example, it has secondary circuits that are separated from brake circuits of the brake system by normally closed valves. The closed valves prevent the air from being drawn out of the secondary circuits and prevent brake fluid from entering the secondary circuits during filling. The secondary circuits can therefore be pre-filled with brake fluid at a separate filling station prior to installation in the vehicle. The closed valves prevent the brake fluid from escaping.

Alternatively, the valves can be actuated by the filling installation during filling and actively opened to connect the secondary circuits with the brake circuits. For this purpose, the filling installation can be connected to a data bus of the vehicle via an adapter and thus transmit control commands to the brake system for opening the valves.

### SUMMARY

The present invention provides a method for filling a brake system of a vehicle, a control device for a brake system of a vehicle, and a corresponding computer program product. Advantageous example embodiments, developments, and improvements of the present invention here emerge from the disclosure herein.

As a result of a generation, for example, of a strong negative pressure or vacuum in the brake system, a subsequent pressure build-up for filling with brake fluid, and a final pressure reduction to ambient pressure, a filling operation has a characteristic pressure curve. The pressure curve can differ from brake system type to brake system type, but is known for each brake system type.

With the approach presented here according to the present invention, at least one control device of the brake system is activated during the filling operation. At least one pressure sensor of the brake system is connected to the control device and can communicate with it. The pressure sensor is used to capture the pressure curve of the filling operation. At least the reference points of the pressure curve expected for this brake system are stored in the control device. The control device evaluates pressure information supplied by the pressure sensor and compares it with the stored information in order to detect the filling operation. The control device is also connected to the valve drives of the brake system. If the filling operation is detected, the control device actuates the valve drives required for connecting the secondary circuits and brake circuits and thus connects the secondary circuits with the brake circuits.

According to an example embodiment of the present invention, a data connection between the filling installation and the brake system is unnecessary and can be omitted. By omitting it, costs and time can be saved. In particular, no adapter is required for connecting the filling installation to a data bus of the vehicle. The plugging in and unplugging of the adapter can also be omitted. This also eliminates the time otherwise required to reach an interface of the data bus twice.

By omitting the data line, there is also no need to coordinate a communication protocol between the filling installation and the vehicle. Thus, the development effort for software of the filling installation and the control device can be reduced.

According to an example embodiment of the present invention, a method for filling a brake system of a vehicle is provided, wherein a filling installation is connected to the brake system and a control device of the brake system is activated, wherein the control device monitors a pressure signal of a pressure sensor of the brake system in order to detect a filling operation carried out by the filling installation, wherein in response to detecting a start of the filling operation, valves of the brake system are activated by the control device, and in response to detecting an end of the filling operation, the valves are deactivated by the control device.

Ideas for embodiments of the present invention may be considered, inter alia, as being based on the concepts and findings described below.

A brake system can be installed dry in a vehicle. An initial filling with brake fluid is required to bring the brake system into a functional state. Filling should be effected without bubbles. A filling operation can be executed from outside the vehicle by a filling installation. The filling operation can comprise a vacuum phase and a pressure phase. In the vacuum phase, air can be removed from the brake system or the brake system can be evacuated. In the pressure phase, the brake system can be filled with brake fluid. The filling operation can be integrated into a vehicle production line as an assembly step. The filling operation can be executed while the vehicle is in production. For filling, a filling head of the filling installation can be placed on a master brake cylinder or a reservoir of the master brake cylinder and connected in a pressure-tight manner. The filling head can be connected to the filling installation via hose lines. The filling installation can, for example, comprise a vacuum pump and a pressure pump.

The brake system can comprise two separate brake circuits and a plurality of secondary circuits. At least one secondary circuit can be used for regulating the brake pressure in a brake circuit. A plurality of valves can be arranged between the particular brake circuit and the secondary circuit. The valves can be actuated by one or more control devices of the brake system. The valves can be arranged in a valve block of the brake system. The secondary circuits can run between the valves within the valve block. The valves can, for example, be normally closed by return springs. The control device or control devices can be connected to the valve block. Control signals for valve drives of the valves may be required for opening the valves. The control signals can be generated by the at least one control device. The control device can be referred to as a brake control device and can actuate the valves, for example for an ABS and/or ESP of the vehicle, during operation of the vehicle.

The control device can be operated in a production mode in order to fill the brake system. The production mode can be deactivated after filling. Alternatively, the production mode can be deactivated at the end of the production line.

The control device can be activated by supplying power. For example, battery voltage can be connected to terminals on the control device for this purpose. The battery voltage can be supplied via a wiring harness of the vehicle. Alternatively, the control device can be powered separately via an adapter or terminals, for example. The battery voltage can be supplied by a battery in the vehicle or by an external energy source, such as a power supply unit. The battery voltage can also be supplied by a voltage converter from a traction voltage of a traction battery of the vehicle. Alternatively, the control device can be powered via the filling head. An additional signal may also be required for activation. The signal can be referred to as a wake-up signal or ignition, for example.

A pressure sensor of the brake system can be powered by activating the control device. If the pressure sensor is powered, it can capture a pressure in the brake system and map it in a pressure signal. When the control device is activated, a reference value of the pressure, which reference value represents the ambient pressure, can be stored. In particular, the pressure sensor can be configured to capture excess pressure. For example, the pressure sensor can have an operating range of 1 bar to several hundred bar. Negative pressure can be outside the operating range, but can also be mapped in the pressure signal. Negative pressure can be mapped with a low accuracy in the pressure signal due to the large operating range.

A start and/or an end of the filling operation can be characterized by characteristic pressure changes. The start and/or the end can be detected, for example, by observing a curve of the pressure signal and/or by reaching stored threshold values. When the valves are activated, the valves can be switched continuously by their valve drives. When deactivating, the valve drives can be switched off, and the valves can be switched to the closed position by their return springs.

The control device can detect the vacuum phase and the pressure phase using the pressure signal. The valves can be activated or switched open during the vacuum phase in order to evacuate the secondary circuits. The valves can be deactivated or switched to the closed position at an end of the pressure phase. In order to detect the vacuum phase, for example, the negative pressure in the brake system mapped in the pressure signal can be detected. The vacuum phase may have already started before the pressure sensor can map the negative pressure in the pressure signal. Due to the negative pressure that already exists in the brake circuits, the secondary circuits can be evacuated particularly quickly. The vacuum phase can also follow a preceding preparation phase. The preparation phase can have a characteristic pressure curve. The control device can detect an end of the preparation phase and detect the start of the vacuum phase at the end of the preparation phase.

The valves can be activated with a time delay once the vacuum phase has been detected. Activation of the valves can be delayed until it is highly probable that a strong negative pressure has built up in the brake circuits. The secondary circuits can then be evacuated particularly quickly.

At the end of the filling operation, the control device can activate a pump of the brake system for emptying at least one low-pressure accumulator of the brake system. The brake system can comprise at least one low-pressure accumulator. In particular, the brake system can comprise one low-pressure accumulator per brake circuit. During control operation of the brake system, brake fluid can be temporarily stored in the low-pressure accumulator in order to regulate the brake pressure in the brake circuit by opening at least one valve. Subsequently, the brake fluid can be conveyed from the low-pressure accumulator back into the brake circuit by a pump of the brake system. The brake system can comprise one pump per low-pressure accumulator. The low-pressure accumulator and the pump can be arranged in the valve block.

At the end of the filling operation, the filling installation can draw off excess brake fluid from a reservoir in the brake system, in order to set a predefined level in the reservoir. This operation can be referred to as leveling the brake system. There is excess brake fluid in at least one low-pressure accumulator after filling at pressure. The pump can convey the brake fluid from the low-pressure accumulator to the reservoir. The pump can be activated for a predefined duration. In particular, the control device can actuate a drive motor of the pump. The drive motor can be coupled to a plurality of pumps. Once the pump is deactivated, the filling of the brake system can be completed.

The filling installation can carry out a leak test of the brake system prior to the filling operation and pressurize the brake system. The control device can detect the leak test using the pressure signal. For the leak test, air can be pumped into the brake system in order to increase the pressure. The pressure can be maintained for a test period and monitored by the filling installation. If the pressure does not drop by more than one pressure tolerance during the test period, the brake system is detected as tight. After the test period, the air can be released from the brake system. After the leak test, ambient pressure may be present in the brake system. The leak test can be part of the preparation phase. The control device can detect the start of the filling operation at an end of the leak test. The valves can remain inactive during the leak test.

The filling operation can be documented in a non-volatile memory of the control device. The non-volatile memory can be an EEPROM, for example. The non-volatile memory can comprise an extra memory area for documenting the filling operation. The memory area can be referred to as a filling byte. The memory area can store different values. Progress of the filling operation can be documented during the filling operation using the different values in the memory. Previous and/or subsequent steps can also be documented. After completion of predefined phases of the filling operation, a value of the filling byte can be set to a predefined value. The filling byte value can be increased gradually or synchronously with the phases of the filling operation. Furthermore, at the end of the filling operation, an error entry about missing brake fluid can be deleted from an error memory of the control device. The production mode of the control device can also be deactivated at the end of the filling operation.

The control device can alternately open and close the valves of the first brake circuit of the brake system and the valves of the second brake circuit of the brake system. The valves can be provided for pulsed actuation. Continuous actuation may not be provided. Repeated opening and closing can prevent the valve drives from being overloaded. Any remaining bubbles can be expelled by the resulting pressure waves.

According to an example embodiment of the present invention, the method is preferably computer-implemented and can be implemented, for example, in software or hardware or in a mixed form of software and hardware, for example in a control device.

The approach presented here according to an example embodiment of the present invention also provides a control device for a brake system of a vehicle, wherein the control device is designed to carry out, control or implement the steps of a variant of the method presented here in corresponding apparatuses.

The control device can be an electrical device comprising at least one computing unit for processing signals or data, at least one memory unit for storing signals or data, and at least one interface and/or one communication interface for reading in or outputting data embedded in a communication protocol. The computing unit can, for example, be a signal processor, a so-called ASIC system, or a microcontroller for processing sensor signals and outputting data signals on the basis of the sensor signals. The memory unit can, for example, be a flash memory, an EPROM, or a magnetic memory unit. The interface can be designed as a sensor interface for reading in the sensor signals from a sensor and/or as an actuator interface for outputting the data signals and/or control signals to an actuator. The communication interface can be designed to read in or output the data in a wireless and/or wired manner. The interfaces may also be software modules that are present, for example, on a microcontroller in addition to other software modules.

A computer program product or a computer program having program code that can be stored on a machine-readable carrier or storage medium, such as a semiconductor memory, a hard disk memory, or an optical memory, and that is used for carrying out, implementing, and/or controlling the steps of the method according to one of the embodiments described above, in particular when the program product or program is executed on a computer or a device, is advantageous as well.

It is pointed out that some of the possible features and advantages of the present invention are described herein with reference to different embodiments. A person skilled in the art recognizes that the features of the control device and of the method can be suitably combined, adapted, or replaced in order to arrive at further embodiments of the present invention.

### BRIEF DESCRIPTION OF THE DRAWINGS

Embodiments of the present invention are described below with reference to the figures, whereby neither the figures nor the description are to be interpreted as limiting the present invention.

FIG. 1 shows a representation of a brake system having a control device according to an exemplary embodiment of the present invention.

FIG. 2 shows a representation of a sequence of a filling operation according to an example embodiment of the present invention.

The figures are merely schematic and not true to scale. Identical reference signs refer to identical or identically acting features.

### DETAILED DESCRIPTION OF EXAMPLE EMBODIMENTS

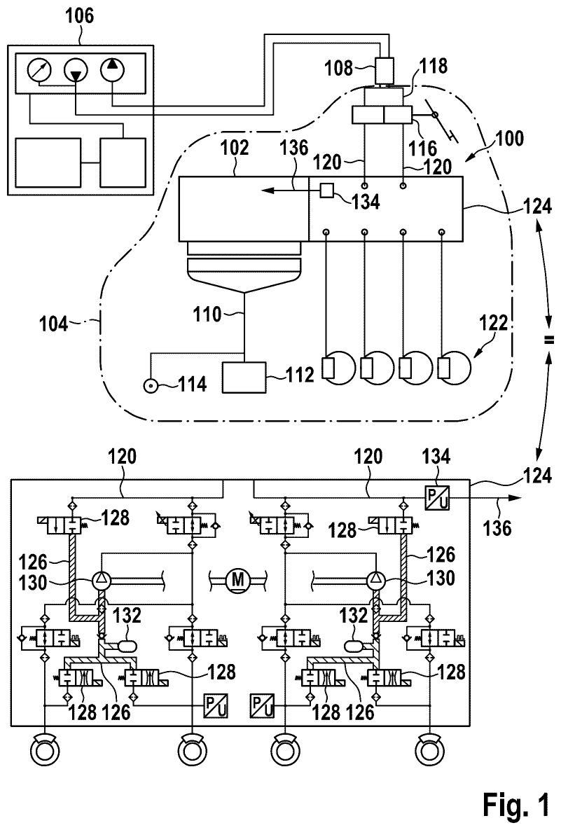

FIG. 1 shows a representation of a brake system 100 having a control device 102 according to an exemplary embodiment during a filling operation according to the approach presented here. The brake system 100 has been installed in a vehicle 104 in an unfilled or empty state as it passes through a production line of the vehicle 104. The vehicle 104 has arrived on the production line at a filling installation 106 for initial filling with brake fluid. The filling installation 106 comprises a filling head 108 and is connected to the brake system 100 via the filling head 108. A negative pressure line and a pressure line lead from the filling head 108 to the filling installation 106. The negative pressure line is connected to a vacuum pump of the filling installation 106. The pressure line is connected to a pressure pump of the filling installation 106.

The control device 102 is powered for the filling operation in order to activate it. Here, for supplying power, a wiring harness 110 of the vehicle 104 is connected to a battery 112 of the vehicle 104 and the control device 102. In addition, the ignition 114 of the vehicle 104 is activated here.

The brake system 100 comprises a master brake cylinder 116 having a reservoir 118. Two separate brake circuits 120 lead from the master brake cylinder 110 to two of the wheel brakes 122 of the vehicle 104. Within a valve block 124 of the brake system 100, the brake system 100 comprises four secondary circuits 126. The secondary circuits 126 are separated from the brake circuits 120 by valves 128. The secondary circuits 126 are connected to two pumps 130 and two low-pressure accumulators 132 of the brake system 100. When the valves 128 are closed, the secondary circuits 126 cannot be filled during the filling operation.

A pressure sensor 134 is arranged in at least one of the brake circuits 120. The pressure sensor 134 is connected to the control device 102. The pressure sensor 134 is powered by the control device 102 during the filling operation. The pressure sensor 134 maps a pressure in the brake circuit 120 in a pressure signal 136. The activated control device 102 monitors the pressure signal 136 in order to detect the filling operation.

For the filling operation, the filling head 108 is connected to the reservoir 118 of the brake system 100 in a pressure-tight manner. During the filling operation, a strong negative pressure is generated in the brake system 100, in order to remove as much air as possible from the brake system 100. In particular, at least a partial vacuum is drawn in the brake system 100 by the vacuum pump. The brake fluid is then pressed into the deflated brake system 100 with excess pressure.

The strong negative pressure is characteristic of the filling operation. In normal operation, no such negative pressure can occur in the brake system 100. The negative pressure is captured by the pressure sensor 134 and mapped in the pressure signal 136. In one exemplary embodiment, the control device 102 detects the filling operation by the characteristic negative pressure.

If the control device 102 detects the filling operation, it activates the valves 128 in order to connect the secondary circuits 126 to the brake circuits 120. After the filling operation, the control device 102 deactivates the valves 128 again.

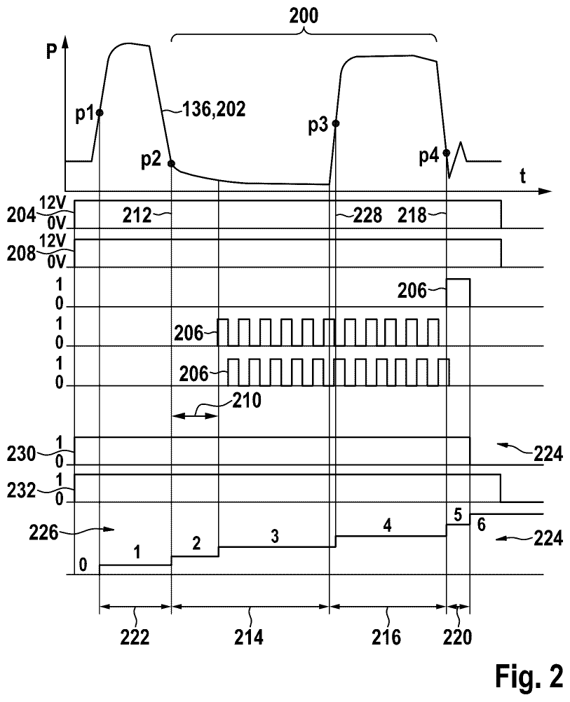

FIG. 2 shows a representation of a sequence of a filling operation 200 of a brake system based on a characteristic pressure curve 202 in the brake system and various signal curves. The pressure curve 202 is generated by a filling installation connected to the brake system, as shown in FIG. 1. Prior to the filling operation 200, the brake system is empty or filled with air at ambient pressure; after the filling operation 200, the brake system is filled with brake fluid at ambient pressure. During the filling operation 200, the pressure in the brake system changes characteristically.

Prior to the filling operation 200, a control device of the brake system to be filled is activated. For this purpose, battery voltage 204 is applied to the control device. By activating the control device, the control device can read in a pressure signal 136 from a pressure sensor of the brake system. The pressure sensor captures the pressure curve 202 and maps it in the pressure signal 136.

The pressure curve 202 or a curve of the pressure signal 136 is shown in a diagram that has the time t in seconds on its abscissa and the absolute pressure p in bar on its ordinate. The control device evaluates the pressure signal 136 in order to detect the filling operation 200. The pressure signal 136 in the control device is compared with stored, expected values p1, p2, p3, p4 of the pressure signal 136 and/or an expected curve of the pressure signal 136, in order to detect the filling operation 200.

If the control device detects the filling operation 200, the control device actuates predefined valves of the brake system via control signals 206, so that secondary circuits of the brake system are also filled with brake fluid during the filling operation 200.

In one exemplary embodiment, an activation signal 208, such as ignition or a wake-up command, is also transmitted for activating the control device prior to the start of the filling operation 200.

In one exemplary embodiment, the control device actuates the valves of the first brake circuit of the brake system alternately with the valves of the second brake circuit of the brake system during the filling operation 200. Thus, in each case, either the valves of the first brake circuit are open and the valves of the second brake circuit are closed or the valves of the first brake circuit are closed and the valves of the second brake circuit are open.

In one exemplary embodiment, the control device actuates the valves with a time delay of a delay duration 210 after a start 212 of the filling operation 200 is detected.

The filling operation 200 comprises a vacuum phase 214 with negative pressure in the brake system and a pressure phase 216 with excess pressure in the brake system. Both the negative pressure and the excess pressure are in each case maintained for holding times, in order to achieve stable conditions in the brake system. In one exemplary embodiment, the negative pressure is mapped in the pressure signal 136, although the pressure sensor is designed to detect a brake pressure during a braking process. However, since the negative pressure can be a maximum of one bar below ambient pressure, the negative pressure is orders of magnitude lower than the brake pressure, which can be several hundred bar. By the time the pressure sensor maps the negative pressure in the pressure signal 136, the start 212 is in the past and the vacuum phase 214 has already begun. Therefore, the control device starts to actuate the valves immediately once the vacuum phase 214 has been detected.

The control device actuates the valves without interruption while the vacuum phase 214 ends and the pressure phase 216 starts. Only if an end 218 of the pressure phase 216 is detected are the valves no longer actuated. The pressure phase 216 is detected if the excess pressure becomes greater than a threshold value p3. The end 218 of the pressure phase 216 is detected if the excess pressure again becomes less than a further threshold value p4. The further threshold value p4 is smaller than the threshold value p3 and is in the ambient pressure range.

In one exemplary embodiment, the control device actuates a pump motor of at least one pump of the brake system via a further control signal 206 if the end 218 of the filling operation 200 is detected. Excess brake fluid is pumped out of at least one low-pressure accumulator of the brake system by the pump and can be extracted by the filling installation. This operation can be referred to as leveling 220 of the brake system.

In one exemplary embodiment, an overall process comprises a leak test 222 prior to the filling operation 200. For this purpose, the empty brake system is subjected to excess pressure via the filling head by feeding compressed air into the brake system. A test pressure is set and held for a test period before the excess pressure is released and ambient pressure is restored to the brake system. If the test pressure does not remain approximately constant during the test period, the brake system is detected as leaking and the filling operation 200 is not initiated.

The leak test 222 is mapped in the pressure curve 202 and thus also in the pressure signal 136. Here, the control device detects the leak test 222 by the fact that the pressure in the brake system rises above a threshold value p1 and, after the test period, falls below a next threshold value p2 again. The threshold value p2 is smaller than the first threshold value p1. In particular, the threshold value p2 is in the range of the ambient pressure.

When the value falls below the threshold value p2, the control device detects the end of the leak test 222 and thus the start 212 of the filling operation 200 and subsequently actuates the valves.

In one exemplary embodiment, progress of the filling operation 200 is documented in a non-volatile memory 224 of the control device. For this purpose, a value of a so-called filling byte 226 of the memory 224 is changed step-by-step if the different phases of the filling operation 200 are detected.

In an exemplary embodiment, the detected start 212 of the vacuum phase 214, a start 228 of the pressure phase 216 when the threshold value p3 is exceeded and the end 218 of the pressure phase 216 when the value falls below the threshold value p4 are documented.

In one exemplary embodiment, the leak test 222 is also documented in the memory 224. When the threshold value p1 is exceeded, the start of the leak test 222 is documented and when the value falls below the threshold value p2, the end of the leak test 222 and the start 212 of the vacuum phase 214 are documented.

In one exemplary embodiment, a start of leveling 220 is documented when the value falls below the threshold value p4, i.e. at the end 218 of the filling operation 200 when the pump motor is activated. Once the pump motor is deactivated, the completion of the entire process is documented in the memory 224.

In one exemplary embodiment, an error entry 230 in the memory 224 of “brake unfilled” is deleted once the pump motor is deactivated.

In one embodiment, changes to the memory 224 are only possible if a production mode 232 of the control device is activated.

Possible embodiments of the present invention are summarized again below or described using slightly different words.

A method for the tester-free filling of a vehicle brake system with a brake control system is presented.

For vacuum filling of a dry vehicle brake system, all regions in the brake system should be dry, tight and capable of being evacuated. However, since the secondary circuits in a brake control system (e.g., ABS, ESP®, etc.) are usually separated from the rest of the brake circuit by hydraulic actuators, these regions can either be pre-filled, the actuators can be designed to open under vacuum, or the corresponding actuators can be actuated during vacuum filling.

The actuation of the actuators is conventionally effected via serial diagnostic communication with the brake control system during vacuum filling. In this case, the brake control system is powered. The actuation of the actuators of the brake control system by means of serial diagnostic communication during vacuum filling is used by most OEMs (original equipment manufacturers). Some OEMs use secondary-circuit-filled brake control systems for various reasons.

By eliminating serial communication for tester-free vacuum filling as presented here, additional costs for secondary-circuit-filled brake control systems or for design modifications to the actuators can be saved. Furthermore, a previously required communication system (tester) including the development of the communication software on the brake filling installations can be dispensed with. Furthermore, handling time on the OEM assembly line for connecting the tester to the communication interface in the vehicle, e.g. via the OBD2 connector, can be saved. In addition, design adjustments to the brake control system, e.g. special pump elements or sealing rings, can be omitted. By eliminating the separate secondary circuit filling, the filling device required for this and the correspondingly complex filling operation can be omitted.

With the approach presented here, automatic detection of the vacuum filling in the OEM assembly plant is effected by the software of the brake control system.

Since vacuum filling is characterized by a specific pressure curve, this is used in the approach presented here for automatic detection by the software and hardware of the brake control system. By means of the pressure sensor in the brake control system, the start of the vacuum filling is automatically detected and the necessary actuator actuations are executed. Furthermore, corresponding progress information is written in the so-called “filling byte” in the non-volatile memory (EEPROM) in the control device of the brake control system. The initial content of the “filling byte” is the value “tester-free vacuum filling not executed.” The value can be a numerical value between zero and six, wherein each numerical value represents corresponding progress information. The function is limited to use in the OEM production plant and can only be executed if the “production mode” is activated in the brake control system. For safety reasons, the “tester-free vacuum filling” function can only be executed at standstill (V<=2 km/h).

In the region of vacuum filling in the OEM assembly line, the vehicle and therefore also the brake control system are powered. For example, the wiring harness can be plugged into the brake control system and the low-voltage battery can be installed or the DC/DC converter can be activated. In addition, the ignition can be switched on or the brake control system can be activated by a corresponding wake-up function in the control device, for example as a result of detecting active vehicle bus communication. Due to a wake-up function in the control device of the brake control system, only the standard voltage supply with battery voltage, for example via terminal 30, is required. This offers a further time and effort advantage for the OEM by eliminating the step of switching on the ignition for the worker on the line.

In a first process step, the vehicle brake is tested for leaks using compressed air at a typical pressure of 3 to 6 bar . The brake control software detects the pressure change, for example, via a relative pressure value p1>2 bar at the pressure sensor of the brake control system and starts the “tester-free vacuum filling” function. In order to save production time, the brake system can also be briefly pressurized to the desired pressure and the pressure then reduced again immediately. This short pressure pulse is sufficient to trigger the “tester-free vacuum filling” function. The start of the “tester-free vacuum filling” function is documented in the non-volatile memory (EEPROM) of the control device of the brake control system using the “tester-free vacuum filling started” value.

In a second process step, the entire brake system is evacuated once the leak test has been completed. The brake control software detects this pressure change, for example, via the relative pressure value p2=0+−1 bar at the pressure sensor of the brake control system and then starts the necessary actuation of the actuators of the brake control system for evacuating and filling the secondary circuits in the brake control system after a defined delay time. The “vacuum phase” process step is documented in the non-volatile memory (EEPROM) of the control device of the brake control system using the “start of vacuum phase” value or, after the defined delay time has elapsed, using the “start of actuator actuations (valves)” value.

In a third process step, the filling installation switches to the filling phase at a typical filling pressure of 3 to 6 bar once the vacuum phase and the vacuum leak test have been completed. The software in the brake control system detects this pressure change, for example, via a relative pressure p3>2 bar at the pressure sensor. The already running actuation of the actuators of the brake control system is not changed or continues to run without any change. The “filling phase” process step is documented in the non-volatile memory (EEPROM) of the control device of the brake control system using the “start of filling phase” value. From this phase onwards, the “tester-free vacuum filling” function is blocked for the future and can no longer be executed, regardless of the “production mode” present in the brake control system.

In a fourth process step, once the filling phase has been completed, the filling installation switches to the leveling phase, in which excess volume in the brake fluid reservoir is drawn off to the maximum permissible level. The filling pressure is reduced during this phase. The brake control software detects this pressure change, for example, via a relative pressure value p4=0+−1 bar at the pressure sensor, terminates the actuations of the actuators of the brake control system for filling the secondary circuits and thereafter starts the required actuation of the actuator for emptying the low-pressure accumulators in the brake control system. The “leveling” process step is documented in the non-volatile memory (EEPROM) of the control device of the brake control system using the “leveling” value. Once the actuator actuation for emptying the low-pressure accumulators has been completed, the “tester-free vacuum filling executed” value is documented and the “brake unfilled” error entry in the brake control system is automatically reset.

Finally, it should be pointed out that terms like “having,” “comprising,” etc. do not exclude other elements or steps and terms like “a” or “an” do not exclude a plurality.

1-10. (canceled)

11. A method for filling a brake system of a vehicle, the method comprising the following steps:
connecting a filling installation to the brake system and activating a control device of the brake system;
monitoring, by the control device, a pressure signal of a pressure sensor of the brake system to detect a filling operation carried out by the filling installation;
in response to detecting a start of the filling operation, activating, by the control device, valves of the brake system; and
in response to detecting an end of the filling operation, deactivation, by the control device, the valves.

12. The method according to claim 11, werein the filling operation includes a vacuum phase and a pressure phase, wherein the filling installation evacuates the brake system during the vacuum phase and fills the brake system with brake fluid during the pressure phase, wherein the control device detects the vacuum phase and the pressure phase using the pressure signal, wherein the valves are activated during the vacuum phase and the valves are deactivated at an end of the pressure phase.

13. The method according to claim 12, wherein the valves are activated with a time delay once the vacuum phase has been detected.

14. The method according to claim 11, wherein the control device activates a pump of the brake system for emptying at least one low-pressure accumulator of the brake system (100) at the end of the filling operation.

15. The method according to claim 11, wherein the filling installation carries out a leak test of the brake system prior to the filling operation and pressurizes the brake system, wherein the control device detects the leak test using the pressure signal.

16. The method according to claim 11, wherein the filling operation is documented in a non-volatile memory of the control device.

17. The method according to claim 11, wherein the control device alternately opens and closes valves of a first brake circuit of the brake system and valves of a second brake circuit of the brake system.

18. A control device for a brake system of a vehicle, wherein the control device is configured to:
monitor a pressure signal of a pressure sensor of the brake system to detect a filling operation carried out by a filling installation connected to the brake system;
in response to detecting a start of the filling operation, activate valves of the brake system; and
in response to detecting an end of the filling operation, deactivate the valves.

19. A non-transitory machine-readable storage medium on which is stored a computer program for filling a brake system of a vehicle, the computer program, when executed by a processor, causing the processor to perform or control the following stesps:
monitoring, by a control device of the brake system, a pressure signal of a pressure sensor of the brake system to detect a filling operation carried out by a filling installation connected to the brake system;
in response to detecting a start of the filling operation, activating, by the control device, valves of the brake system; and
in response to detecting an end of the filling operation, deactivation, by the control device, the valves.
